(19) United States
(12) Patent Application Publication
(10) Pub. No.: US 2026/0227994 A1
(43) Pub. Date: Aug. 6, 2026

(54) System and Method for AI-Driven Predictive Firmware Update Orchestration with Self-Healing Capabilities for a Fleet of IoT Devices

(71) Applicant: DigiCert, Inc., Lehi, UT (US)

(72) Inventor: Mahendra Shelke, Santa Clara, CA (US)

(73) Assignee: DigiCert, Inc., Lehi, UT (US)

(21) Appl. No.: 19/636,464

(22) Filed: Apr. 1, 2026

Related U.S. Application Data
(63) Continuation-in-part of application No. 18/897,053, filed on Sep. 26, 2024.

(51) Int. Cl. G06F 8/65; G06F 11/14

(52) U.S. Cl. CPC G06F 8/65; G06F 11/1433; G06F 2201/805

(57) ABSTRACT

Systems and methods are provided for AI-driven predictive firmware update orchestration with self-healing capabilities for a fleet of Internet of Things (IoT) devices, embedded devices, resource-constrained devices, and the like. A device trust manager, according to one implementation, includes a risk assessment module employing machine learning models trained on historical update outcomes, configured to a) receive telemetry data and operational parameters from an IoT device fleet and b) generate a success probability score associated with deploying a firmware update to one or more IoT devices of the IoT device fleet. The device trust manager also includes a scheduling engine configured to determine an optimized update schedule based on the telemetry data, operational parameters, and success probability score, and an update deployment module configured to deploy the firmware update to the one or more IoT devices according to the optimized update schedule.

### CROSS REFERENCE TO RELATED APPLICATION

The present application is a Continuation in Part (CIP) of App. No. 18/897,053, filed September 26, 2024, titled “Device Trust System for Managing a Large Number of IoT Devices in a Distributed Environment,” the contents of which are incorporated by reference herein.

### FIELD OF THE DISCLOSURE

The present disclosure relates generally to networking. More particularly, the present disclosure relates to operating a distributed trust system having at least three layers for managing a fleet of Internet of Things (IoT) devices or embedded devices, specifically to schedule and conduct firmware updates for the IoT device fleet.

### BACKGROUND

Internet of Things (IoT) devices (e.g., embedded devices, connected devices, etc.) are manufactured devices that may be built for one purpose (e.g., refrigerator for keeping food cool), but also include embedded processing functionality (e.g., microprocessors, memory, etc.) that allow the device to communicate over the Internet for communicating telemetry information to a centralized management device, download firmware updates, and for performing other functions. In typical systems with IoT device monitoring and management, it can be possible for a hacker to interfere with normal operations. News articles have reported hackers tapping into a baby monitor and peering into homes, software flaws in medical devices leaving these devices vulnerable to hackers and taking industrial control systems hostage. Therefore, improving security with respect to IoT devices and systems in which IoT devices may be monitored is critical for the safety and security of users. Specifically, users want to know for sure whether or not their devices can be trusted to perform essential functions, such as regulating the flow of medicine or insulin into their bodies, properly locking or unlocking doors to their houses, properly controlling heating and air conditioning systems in an office or home, etc. Improving the security of IoT device monitoring and management systems is necessary to reduce financial damage, data loss, regulatory violations, customer distrust, etc. Such systems should prevent theft of private user data, unauthorized system access, end user exploitation, etc. Also, such systems should prevent counterfeit devices, data privacy violations, data integrity compromises, device or system hostage situations, unauthorized system access, infrastructure disruption, etc.

### BRIEF SUMMARY

The present disclosure relates to systems and methods for scheduling software and firmware updates for a cluster (or fleet) of IoT devices or embedded devices deployed in a specific environment. In one implementation, a device trust manager, which may be arranged in a backend layer of a three-layer architecture, includes a risk assessment module configured to receive telemetry data and operational parameters from an IoT device fleet and generate a success probability score associated with deploying a firmware update to one or more IoT devices of the IoT device fleet. The device trust manager also includes a scheduling engine configured to determine an optimized update schedule based on the telemetry data, operational parameters, and success probability score. Also, the device trust manager includes an update deployment module configured to deploy the firmware update to the one or more IoT devices according to the optimized update schedule.

In some embodiments, the device trust manager may further include a historical database configured to store metrics of firmware update procedures conducted by the device trust manager over time. The device trust manager may also include a continuous learning module configured to use aggregated data of the metrics of firmware update procedures from the historical database to retrain a Machine Learning (ML) model of the risk assessment module. The action of retraining the ML model, for example, may use federated learning techniques.

The device trust manager described herein may further include a failure detection module configured to monitor the IoT device fleet during or after the update deployment module deploys the firmware update in order to predict a failure condition. The failure detection module, for instance, may be configured to detect anomalies based on real-time telemetry data received from the IoT device fleet. In addition, the device trust manager may include an automated remediation engine that, in response to the failure detection module predicting the failure condition, may be configured to automatically perform a remediation action. The remediation action, according to various embodiments, may include a) retrying deployment of the firmware update, and/or b) rolling back the firmware update to a previously installed version.

According to some implementations, the device trust manager may further include a management interface dashboard configured to display a) a risk report, b) an update schedule status, c) a list of remediation actions taken, and/or d) health information. The scheduling engine, in some embodiments, may be configured to determine the optimized update schedule by analyzing device usage patterns, environmental conditions, and device-specific risk factors. The update deployment module, for example, may be configured to deploy the firmware update by transmitting the firmware update via one or more intermediate proxy devices arranged in a Rendezvous Zone (RZ). The IoT device fleet, for instance, may include a plurality of resource-constrained devices or embedded devices having local agents configured to communicate with the device trust manager.

### BRIEF DESCRIPTION OF THE DRAWINGS

The present disclosure is illustrated and described herein with reference to the various drawings, in which like reference numbers are used to denote like system components/method steps, as appropriate, and in which:

FIG. 1 is a diagram illustrating a three-layer trust system, according to various embodiments of the present disclosure.

FIG. 2 is a block diagram illustrating the device trust portfolio shown in FIG. 1, according to various embodiments.

FIG. 3 is a diagram illustrating a three-layer distributed system for conducting security and authentication services, according to various embodiments.

FIG. 4 is a diagram illustrating pillars of a device trust system, according to various embodiments.

FIG. 5 is a diagram illustrating a three-layer distributed infrastructure including details of the device trust manager shown in FIGS. 1 and 2, according to various embodiments.

FIG. 6 is a block diagram illustrating a proxy/agent representing one or more of the components of the three-layer trust systems, according to various embodiments.

FIG. 7 is a block diagram illustrating a computing system representing the digital trust system, proxy devices, and/or Internet of Things (IoT) devices shown in the previous figures, according to various embodiments.

FIG. 8 is a block diagram illustrating a device trust manager for updating IoT devices, according to various embodiments.

FIG. 9 is a flow diagram illustrating a method for scheduling firmware updates for an IoT device fleet, according to various embodiments.

FIGS. 10-13 are workflows illustrating processes for operating firmware updating and deployment systems, according to various embodiments.

### DETAILED DESCRIPTION

The present disclosure is directed to systems and methods for providing digital trust in a communication network. With respect to device trust, the present disclosure provides a three-layered distributed system that may be deployed throughout a network, i.e., the Internet and other networks. The distributed trust system may be configured, for example, to manage multiple Internet of Things (IoT) devices, embedded devices, or connected devices, even millions or tens of millions of IoT-type devices.

According to some embodiments, the present disclosure may include distributed systems that may include multiple IoT devices distributed throughout a network. Each IoT device, for example, may be embedded with a local agent that is configured to perform processing and/or computing functionality for the respective IoT device. However, some of the functionality of the agents embedded in conventional IoT devices may be transferred or offloaded to an intermediate proxy device that is configured to operate on behalf of a group of IoT devices and work as a middleman between the millions of IoT devices and a single centralized management system. The intermediate proxy devices may be arranged in a Rendezvous Zone (RZ) at edge locations of the network and interposed between the backend entity and the multiple IoT devices. Each RZ proxy device may be configured to perform trust and security functionality on behalf of one or more IoT devices of the multiple IoT devices.

Therefore, the intermediate proxy devices can regulate the communication flow between the top and bottom layers of the distributed system and assist the management system at the top layer (e.g., backend device) with certification, security, software/firmware updates, etc. The backend entity of the distributed system may then be configured to manage the multiple IoT devices in a more efficient and effective manner.

### Three-Layer Trust System

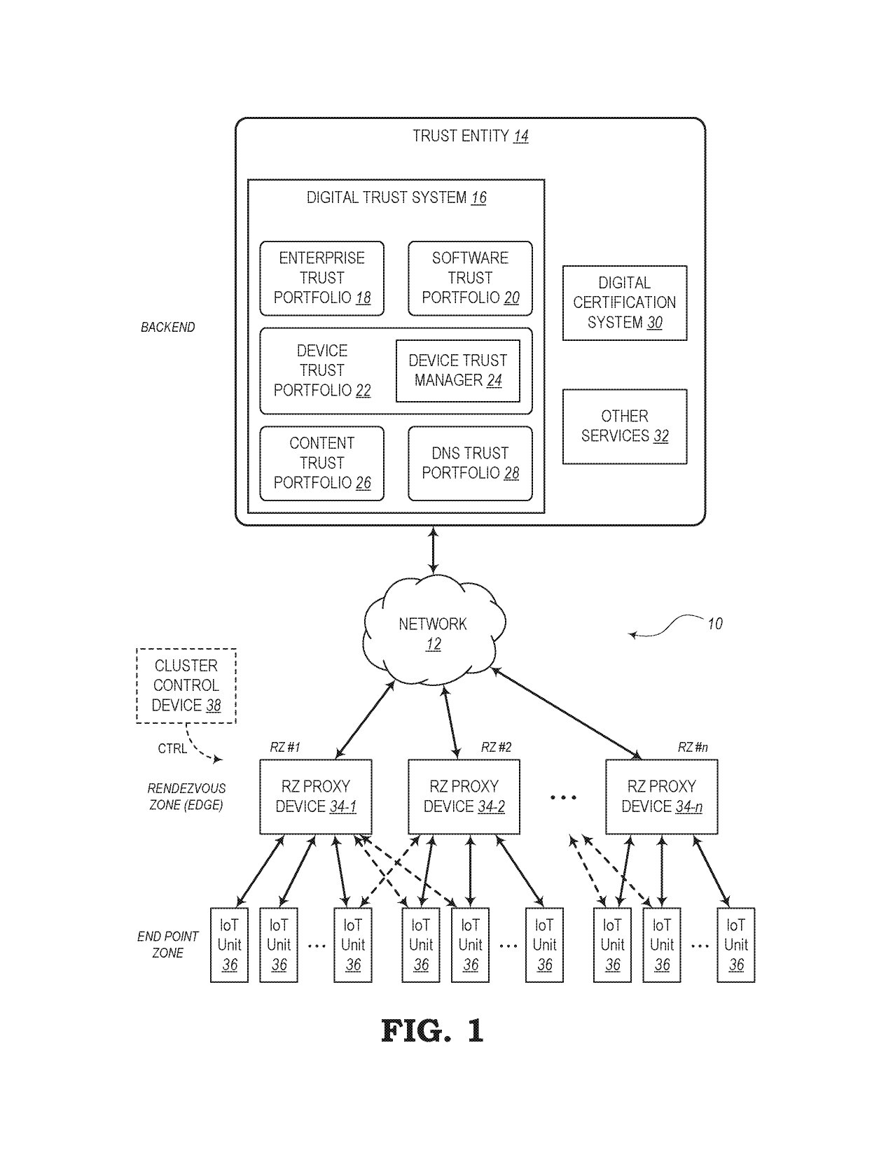

FIG. 1 is a diagram illustrating an embodiment of a three-layer trust system 10 configured to operate over a network 12, such as the Internet, WANs, LANs, and a combination thereof. The three-layer trust system 10 includes a top layer acting as a backend, a middle layer referred to herein as a Rendezvous Zone (RZ), and a low layer or “end point zone” where end user devices and Internet of Things (IoT) devices may be utilized.

The backend (i.e., top layer of the three-layer trust system 10) includes a trust entity 14 configured to perform various trust services, such as device certification, cyber security, etc. In one example, the trust entity 14 may be configured as or extend the functionality of a digital certificate management platform. In some embodiments, the trust entity 14 may include a digital trust system 16, including at least an enterprise trust portfolio 18, a software trust portfolio 20, a device trust portfolio 22 (which includes at least a device trust manager 24), a content trust portfolio 26, and a Domain Name System (DNS) trust portfolio 28.

In some embodiments, the enterprise trust portfolio 18 may include public trust services, private trust services, Certificate Lifecycle Management (CLM) services, trust lifecycle management services, Public Key Infrastructure (PKI) services, etc. The software trust portfolio 20 may include software trust management services. In addition to the device trust manager 24, the device trust portfolio 22 may also include an IoT trust management service, trust core Software Development Kit (SDK), etc. In some embodiments, the content trust portfolio 26 may include a document trust management service. Also, the DNS trust portfolio 28 may include DNS management services, performance monitoring services, etc.

Also, according to some embodiments, the trust entity 14 may further include a digital certification system 30 or other similar services to enable the trust entity 14 to act as a Certificate Authority (CA). The trust entity 14 may also include other services 32 and/or other related security and trust systems. For example, the trust entity 14 may be configured to provide account services for managing roles, groups, users, and policies. The trust entity 14 can also include validation services, such as organization validity, domain validity, individual identity, etc. Furthermore, the trust entity 14 may be configured to provide certificate and registration authority services, such as the issuance of digital certificates. In some cases, the trust entity 14 can also provide platform services (e.g., Kubernetes, Docker, authentication, authorization, shared services, etc.).

Typically, a backend device may be configured to manage a number of IoT devices directly. However, the embodiments of the present disclosure are configured to use one or more intermediate layers between the backend (e.g., trust entity 14) and the IoT devices at the far reaches of the Internet. In particular, the embodiment shown in FIG. 1 includes the RZ, which includes a plurality of RZ proxy devices 34-1, 34-2, …, 34-n positioned at the edge of the three-layer trust system 10 within range of a plurality of IoT units 36 (e.g., IoT devices, embedded devices, connected devices, resource-constrained devices, etc.). An IoT unit 36 may be any suitable type of manufactured device (e.g., electronic device) having a specific purpose that might not necessarily be associated with network communications.

For example, the IoT units 36 may have a primary function as a refrigerator, freezer, oven, stove, kitchen range, microwave oven, dishwasher, coffee maker, espresso machine, toaster, toaster oven, air fryer, blender, mixer, food processor, juicer, slow cooker, pressure cooker, ice maker, washer, dryer, vacuum cleaner, barista machine, HVAC system, utility meter, smart door lock, security system, smoke detector, carbon monoxide detector, measuring and testing device, heartrate monitor, glucose monitor, temperature sensor, smart watch, smart ring, network equipment, network switch, router, modem, Wi-Fi access point, vending machine, sensor, camera, autonomous vehicle, medical equipment, personal medical device, medication administering device, or other electronic or manufactured device. In addition to this primary function, the IoT unit 36 may also be equipped with some type of computing, processing, digital storage, and/or connectivity functionality embedded therein for the purpose of allowing diverse services that may normally be provided to IoT devices.

In some embodiments, the three-layer trust system 10 may also include a cluster control device 38 configured to control the clustering of IoT units 36 into groups associated with each of the RZ proxy devices 34. The clustering may be conducted based on the proximity in location between each IoT unit 36 and each RZ proxy device 34. Also, clustering may be conducted based on a load balancing scheme used to balance the load on each RZ proxy device 34. Also, if one or more RZ proxy devices 34 are overloaded, faulty, etc. and/or are experiencing excessive latency, the cluster control device 38 may be configured to dynamically regroup the IoT units 36 with the available RZ proxy devices 34 as needed.

### Device Trust Portfolio

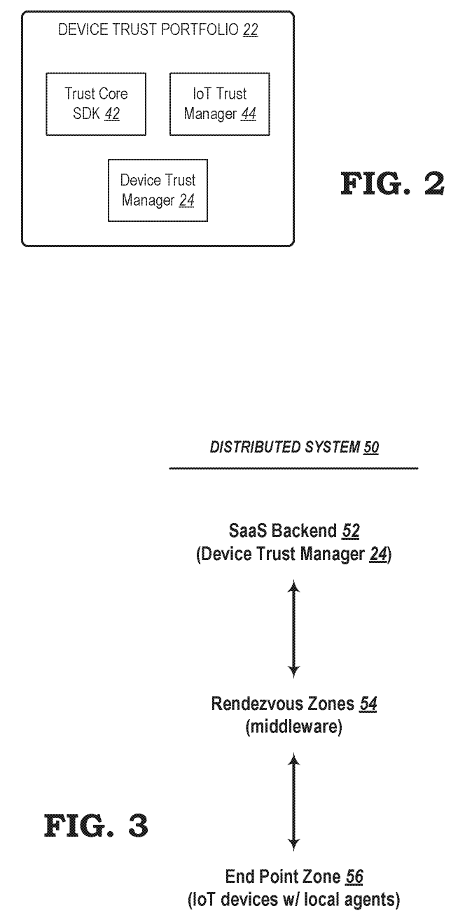

FIG. 2 is a block diagram illustrating an embodiment of the device trust portfolio 22 shown in FIG. 1. In this embodiment, the device trust portfolio 22 includes the device trust manager 24 and further includes a trust core SDK 42 (e.g., TrustCore) and IoT trust manager 44 and may further include other services, software, and functions. The device trust portfolio 22 may be simple to use, fully integrated, and offer end-to-end device security.

The trust core SDK 42 may be configured to enable full stack development for real-time embedded security, secure transport protocols, and application security. The trust core SDK 42 may include an IoT device developer kit and may offer key protection and management. Also, the trust core SDK 42 may include a 1) Trust Abstraction Platform that may be integrated with any secure element, 2) Crypto Abstraction Platform that may comply with export/import controls, 3) Secure Transport Protocol Stack that may be integrated with secure elements, etc. The trust core SDK 42 may include various protocols, such as Simple Certificate Enrollment Protocol (SCEM), Message Queuing Telemetry Transport (MQTT) protocol (e.g., MQTT 3.1.1 / 5.0 client), PQC / Dilithium, FIPS 140-2/3, OpenSSL 1.1, 3.0, etc. for various clients and connectors. Also, in some embodiments, the trust core SDK 42 may be Operating System (OS) and processor agnostic, may have a small memory footprint, and may include C source code.

The IoT Trust Manager 44 may be configured as CLM for the IoT units 36. The PKI management solution may include embedding and managing device identity at scale through the provisioning and lifecycle management of digital certificates. The IoT Trust Manager 44 may support various systems in private Certificate Authority (CA), public CA, and/or Enterprise JavaBeans Certificate Authority (EJBCA) environments. Also, the IoT trust manager 44 may support CSA Matter PAA and PAI, flexible workflows built for IoT, EST, ACME, SCEP, CMPv2, REST, batch certificate issuance, PQC / Dilithium, on-premises gateway, etc. and may be built on any suitable security platform with SaaS and on-premises offerings.

The Device Trust Manager 24 may be built on an IoT Product Security Platform that simplifies device registration, provisioning, updates, and security monitoring. Also, the device trust manager 24 may ensure deployments and management at scale. Also, the device trust manager 24 may support single, bulk, and/or Just In Time (JIT) device registration, MQTT for secure communications and device updates, device software vulnerability scanning, and SBOM monitoring for Common Vulnerabilities and Exposures (CVEs). Also, device trust manager 24 may be configured for delivery of signed software updates (e.g., Over the Air (OTA) updates), may be integrated with the IoT Trust Manager 44 for Certificate Lifecycle Management (CLM), may provide zero touch provisioning to IoT platforms, may include device security event monitoring with Security Information and Event Management (SIEM) integrations, etc. Furthermore, the device trust manager 24 may support Trust Edge agents (e.g., powered by Trust Core), provide support for Linux, Windows, Real-Time Operating Systems (RTOSs), and may be built on any suitable cyber security and/or certification system (e.g., trust entity 14, SaaS system, etc.) with on-premises offerings.

### Distributed System

FIG. 3 is a diagram illustrating an embodiment of a distributed system 50 for conducting security and authentication services and may include many similarities to the three-layer trust system 10 of FIG. 1. As shown, the distributed system 50 may include a SaaS backend 52, which may include, for example, the device trust manager 24 shown in FIGS. 1 and 2. The distributed system 50 may also include one or more Rendezvous Zones (RZ) 54, which may include middleware for enabling distributed functionality for providing cyber security, certification, identity, and other related services for a plurality of end user devices and/or IoT devices. In some embodiments, the RZ 54 may include a fog layer and an edge layer, whereby the fog layer is arranged between the SaaS backend 52 layer and the edge layer. In this respect, both the fog layer and edge layer may include middleware and/or proxy functionality for operating on behalf of multiple IoT devices (e.g., millions of IoT devices) with respect to the single, centralized SaaS backend 52 providing device trust services. At the bottom of the distributed system 50 is an end point zone 56, which is where the IoT devices (e.g., IoT units 36) may be arranged. In particular, each of the IoT devices in the end point zone 56 may include a local agent configured to operate with the middleware within the corresponding intermediate proxy components (e.g., RZ proxy devices 34) in the RZ 54.

### Pillars of the Device Trust System

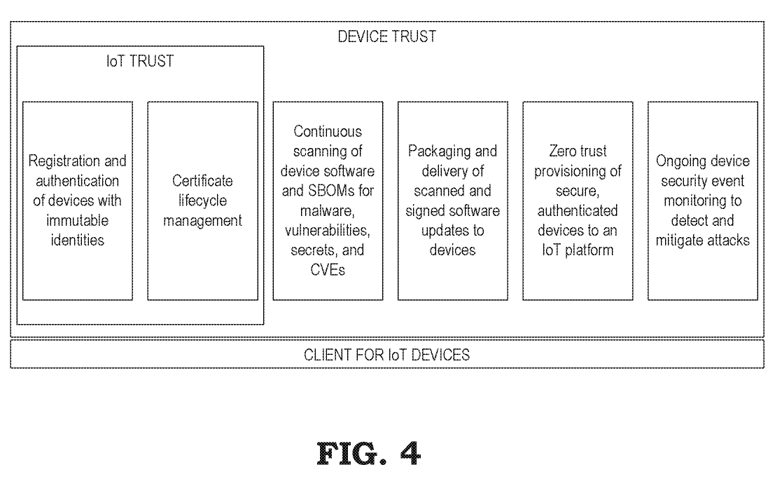

FIG. 4 is a diagram showing an example of six pillars of a device trust system, such as the trust entity 14, SaaS backend 52, etc. In some embodiments, the first two pillars may include registration/authentication and CLM, which may be included normally in an IoT trust management component (e.g., IoT trust manager 44) and now incorporated as part of a device trust component (e.g., device trust manager 24). The device trust system may include device software and Software Bill of Material (SBOM) scanning, signed software updates, zero touch provisioning, and security event monitoring included in the next four pillars. The six pillars of the device trust manager may operate with a local agent embedded on the IoT devices, which may be referred to as a trust edge at lowest layer of the end point zone 56.

According to some embodiments, Pillar #1 may include Registration and Authentication of devices with immutable identities based on a hardware RoT. Registration may be done for single devices or bulk devices and may include Just In Time (JIT) inventory processing during manufacturing. Authentication may include a "birth” (e.g., manufacturing) credential and may include a unique x.509 certificate, a shared x.509 with other related products, symmetric key, passcode, etc. Roots of Trust (RoT) may include TPM 1.2, 2.0, PKCS #11 secure elements, etc.

Also, Pillar #2 may include Certificate Lifecycle Management (CLM) for birth and operational certificates. Digital certificates (e.g., birth certificates) may include single certificate issuance, bulk certificate issuance, CSA Matter DAC, device keys protected by secure elements, server-side key generation, etc. Operational Certificates may include x.509 certificates, CSA Matter NOC, an ability to exchange birth credential for an operational x.509 certificate, etc.

Pillar #3 may include Software and SBOM Scanning, such as continuous scanning of device software and SBOMs for malware, vulnerabilities, secrets, Common Vulnerabilities and Exposures (CVEs), etc. Threat Detection may include scanning all device software components, identifying malware, identifying secrets, identifying vulnerabilities, etc. SBOM may Autogenerate SBOM from ReversingLabs scan, Manually upload of SBOM, CycloneDX SBOM support, etc. Continuous Monitoring may include continuous scanning of SBOM against CVE databases, notifications when new CVEs are detected in SBOM, grouping of affected devices, etc. This can also include device attestation (integrity of the device).

Pillar #4 may include Device Updates, such as for packaging and delivery of scanned and signed software updates to devices. Software updates may include Packaging, Versioning, Targeting updates to groups, Updates over MQTT, etc. Operating Systems may include RTOS, Linux, Windows, etc.

Pillar #5 may include Zero touch provisioning of secure, authenticated devices to an IoT platform. The IoT Platform Onboarding may include automated device onboarding (provisioning), automated device offboarding (de-provisioning), etc. Dynamic Endpoint Assignment may include MQTT endpoint assignment, policy-based assignment, etc. IoT Platform Connectors may include AWS IoT Core, Azure IoT DPS, Azure IoT Hub, Azure Event Grid MQTT, BYO/Custom, etc.

Pillar #6 may include Security event monitoring, such as ongoing device security event monitoring to detect and mitigate attacks. Device-side policies may include delivering security monitoring policies to devices, monitoring for failed logins, device tampering, etc. Alerting may include customizable alerts (e.g., alerts after X failed login attempts), forward security events to a Security Information and Event Manager (SIEM), etc. SIEM Connectors, for example, may include Splunk, etc.

### Distributed Architecture

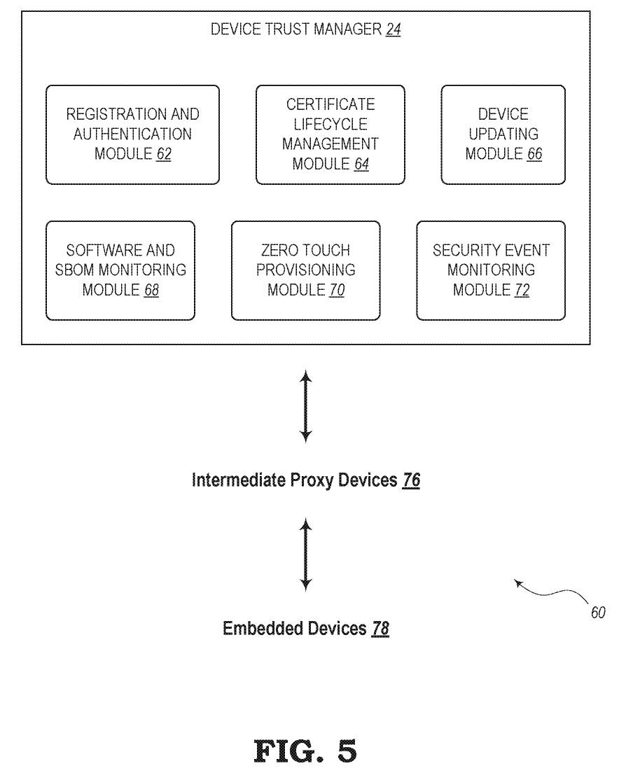

FIG. 5 is a diagram illustrating another embodiment of a three-layer distributed infrastructure 60. The top layer includes the device trust manager 24, which may include a registration and authentication module 62, a Certificate Lifecycle Management (CLM) module 64, a device updating module 66, a software and SBOM monitoring module 68, a zero-touch provisioning module 70, and a security event monitoring module 72. A middle layer includes intermediate proxy devices 76. In some cases, the middle layer may include multiple middle layers interposed between the top layer (i.e.., device trust manager 24) and a bottom layer that includes the embedded devices 78 (e.g., IoT units 36, IoT devices, connected devices, resource-constrained devices, etc.).

### Proxy/Agent

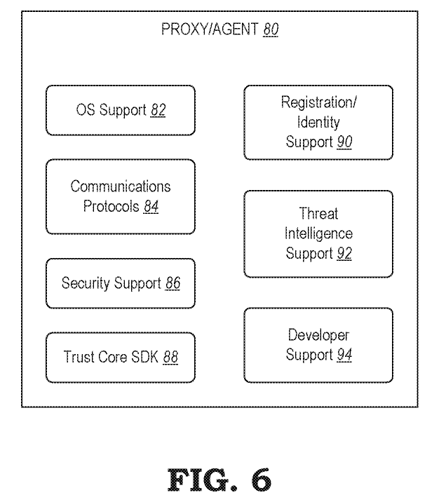

FIG. 6 is a block diagram illustrating an embodiment of a proxy/agent 80 which may be implemented in the middleware of the intermediate proxy devices 76 and/or in the local agent of the embedded devices 78. In some cases, portions of the proxy/agent 80 may be arranged and/or coded in the proxy devices while other portions may be arranged or coded in the embedded devices. According to some embodiments, certain portions may be implemented in both the proxy devices and embedded devices. One goal, however, may be to move the processing and/or computing functionality normally embedded within the IoT devices or embedded devices to the intermediate proxies to allow the proxies to act on behalf of one or more IoT devices. This allows a simpler or less complex implementation for each of the millions of IoT devices and also allows for better coordination of firmware updates, security policies, etc. As shown, the proxy/agent 80 includes OS support 82, communications protocols 84, security support 86, trust core SDK 88, registration/identity support 90, threat intelligence support 92, and developer support 94.

### Computing System

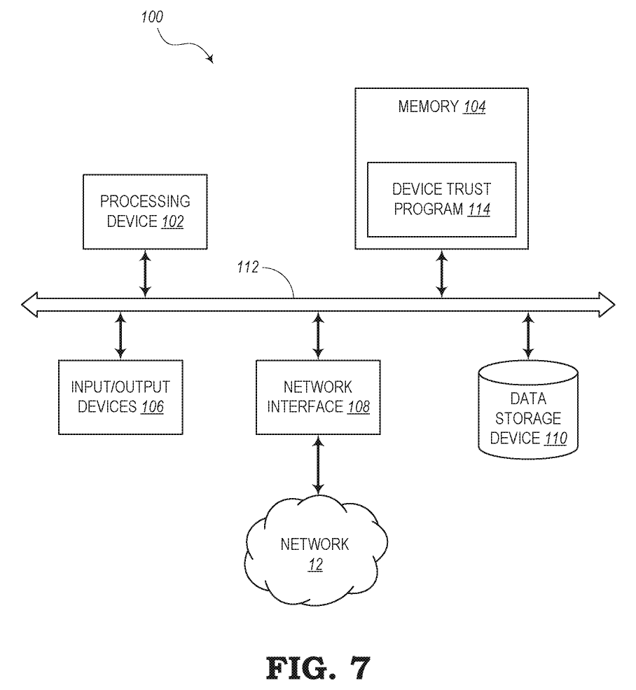

FIG. 7 is a block diagram illustrating an embodiment of a computing system 100, which may represent the digital trust system 16, device trust manager 24, RZ proxy devices 34, local agents embedded in the IoT units 36, the IoT units 36 themselves, proxy/agent 80, and/or other system or device included in a distributed system in which security, firmware updates, etc. are managed for a plurality of IoT devices. The computing system 100 may be a digital computer that, in terms of hardware architecture, generally includes a processing device 102, a memory 104, input/output (I/O) devices 106, a network interface 108, and a data storage device 110. It should be appreciated by those of ordinary skill in the art that FIG. 7 depicts the computing system 100 in an oversimplified manner, and a practical embodiment may include additional components and suitably configured processing logic to support known or conventional operating features that are not described in detail herein. The components (102, 104, 106, 108, 110) are communicatively coupled via a local interface 112. The local interface 112 may be, for example, but not limited to one or more buses or other wired or wireless connections, as is known in the art. The local interface 112 may have additional elements, which are omitted for simplicity, such as controllers, buffers (caches), drivers, repeaters, and receivers, among many others, to enable communications. Further, the local interface 112 may include address, control, and/or data connections to enable appropriate communications among the aforementioned components.

The processing device 102 is a hardware device for executing software instructions. The processing device 102 may be any custom made or commercially available processor, a Central Processing Unit (CPU), an auxiliary processor among several processors associated with the computing system 100, a semiconductor-based microprocessor (in the form of a microchip or chipset), or generally any device for executing software instructions. When the computing system 100 is in operation, the processing device 102 is configured to execute software stored within the memory 104, to communicate data to and from the memory 104, and to generally control operations of the computing system 100 pursuant to the software instructions. The I/O devices 106 may be used to receive user input from and/or for providing system output to one or more devices or components.

The network interface 108 may be used to enable the computing system 100 to communicate on a network, such as the Internet. The network interface 108 may include, for example, an Ethernet card or adapter or a Wireless Local Area Network (WLAN) card or adapter. The network interface 108 may include address, control, and/or data connections to enable appropriate communications on the network. A data storage device 110 (e.g., one or more databases, data stores, etc.) may be used to store data. The data storage device 110 may include volatile memory elements (e.g., random access memory (RAM, such as DRAM, SRAM, SDRAM, and the like)), nonvolatile memory elements (e.g., ROM, hard drive, tape, CDROM, and the like), and combinations thereof.

Moreover, the data storage device 110 may incorporate electronic, magnetic, optical, and/or other types of storage media. In one example, the data storage device 110 may be located internal to the computing system 100, such as, for example, an internal hard drive connected to the local interface 112 in the computing system 100. Additionally, in another embodiment, the data storage device 110 may be located externally to the computing system 100 such as, for example, an external hard drive connected to the I/O devices 106 (e.g., SCSI or USB connection). In a further embodiment, the data storage device 110 may be connected to the computing system 100 through a network, such as, for example, a network-attached file server.

The memory 104 may include volatile memory elements (e.g., random access memory (RAM, such as DRAM, SRAM, SDRAM, etc.)), nonvolatile memory elements (e.g., ROM, hard drive, tape, CDROM, etc.), and combinations thereof. Moreover, the memory 104 may incorporate electronic, magnetic, optical, and/or other types of storage media. Note that the memory 104 may have a distributed architecture, where various components are situated remotely from one another but can be accessed by the processing device 102. The software in memory 104 may include one or more software programs, each of which includes an ordered listing of executable instructions for implementing logical functions. The software in the memory 104 includes a suitable Operating System (O/S) and one or more programs. The O/S essentially controls the execution of other computer programs, such as the one or more programs, and provides scheduling, input-output control, file and data management, memory management, and communication control and related services. The one or more programs may be configured to implement the various processes, algorithms, methods, techniques, etc. described herein.

The computing system 100 further includes a device trust program 114 that may be implemented in any suitable combination of hardware (e.g., configured in the processing device 102) and/or software/firmware (e.g., configured in the memory 104). The device trust program 114 may be stored in any suitable non-transitory computer-readable media (e.g., the memory 104) and may include computer logic or code having instructions that enable or cause the processing device 102 to perform certain actions as discussed in the present disclosure. It may be noted that the device trust program 114 may include different functionality, depending on the layer on which it is deployed. Therefore, the top layer backend system may be configured as a centralized system for managing millions of IoT devices via intermediate RZ devices. Also, the functionality of the device trust program 114, when implemented on the RZ, edge layer, fog layer, etc., may enable a representation or working on behalf of a number of nearby IoT devices and communicating with both the corresponding cluster of IoT devices for which each one is representing and further communicating with the centralized system. Furthermore, the device trust program 114, when implemented on the lowest layer (i.e., as an agent embedded in each IoT device), is configured to discover nearby proxy devices and connect with one or more, as needed, to allow the proxy devices to operate on its behalf for various purposes, such as monitoring the status of the IoT device, receive telemetry information, download new firmware updates, etc.

Of note, the general architecture of the computing system 100 can define any device described herein. However, the computing system 100 is merely presented as an example architecture for illustration purposes. Other physical embodiments are contemplated, including virtual machines (VM), software containers, appliances, network devices, and the like.

In an embodiment, the various techniques described herein can be implemented via a cloud service. Cloud computing systems and methods abstract away physical servers, storage, networking, etc., and instead offer these as on-demand and elastic resources. The National Institute of Standards and Technology (NIST) provides a concise and specific definition which states cloud computing is a model for enabling convenient, on-demand network access to a shared pool of configurable computing resources (e.g., networks, servers, storage, applications, and services) that can be rapidly provisioned and released with minimal management effort or service provider interaction. Cloud computing differs from the classic client-server model by providing applications from a server that are executed and managed by a client’s web browser or the like, with no installed client version of an application required. The phrase “Software as a Service” (SaaS) is sometimes used to describe application programs offered through cloud computing. A common shorthand for a provided cloud computing service (or even an aggregation of all existing cloud services) is “the cloud.”

Therefore, according to various embodiments, the present disclosure may be directed to a distributed system including multiple Internet of Things (IoT) devices distributed throughout a network, where each IoT device is embedded with a local agent configured to perform processing and/or computing functionality. The distributed system may also include a backend entity configured to manage the multiple IoT devices. Furthermore, the distributed system may include multiple Rendezvous Zone (RZ) proxy devices communicatively interposed at edge locations in the network between the backend entity and the multiple IoT devices, wherein each RZ proxy device may be configured to perform trust and security functionality on behalf of one or more IoT devices of the multiple IoT devices.

In some embodiments, the multiple IoT devices may include millions of IoT devices distributed across the globe, wherein the backend entity may be configured as a Certificate Authority (CA) and/or Software as a Service (SaaS) system for securely managing the millions of IoT devices. The distributed system may further include a cluster control device arranged on an RZ layer with the multiple RZ proxy devices for controlling how the IoT devices are clustered with respect to corresponding RZ proxy devices.

The present disclosure is also directed to a device trust manager according to some embodiments. For example, the device trust manager may be configured at a backend of a trust system having at least three deployment layers. The device trust manager may include a processing device and memory that is configured to store a device trust program having computing logic. The computing logic, for example, may be configured to enable or program the processing device to perform a step of managing multiple Internet of Things (IoT) devices distributed at a low level of the trust system, wherein each IoT device may have a local agent embedded therein. The computing logic may also enable the processing device to communicate with multiple Rendezvous Zone (RZ) proxy devices interposed at edge locations between the device trust manager and the multiple IoT devices. Also, the computing logic may enable the processing device to conduct trust and security functions for the multiple IoT devices via the multiple RZ proxy devices and local agents, each RZ proxy device operating on behalf of one or more IoT devices of the multiple IoT devices.

The device trust manager may be part of a Certificate Authority (CA) configured to securely identify and manage the IoT devices. The computing logic may further enable the processing device to collect analytics obtained throughout the trust system and provide threat intelligence for the multiple IoT devices. The computing logic may also enable the processing device to record information regarding software or firmware versions and updates with respect to the multiple IoT devices and to download firmware updates as needed to the multiple IoT devices via the RZ proxy devices.

The device trust program stored on the device trust manager, for example, may include a) a registration and authentication module, b) a certificate lifecycle management module, c) a device updating module, d) a software and Software Bill of Materials (SBOM) monitoring module, e) a zero-touch provisioning module, and/or f) a security event monitoring module. In some embodiments, the device trust manager may be configured as a cloud-based Software as a Service (SaaS) system. Also, the device trust manager may further include a set of microservices for multiple clients, wherein the device trust manager may be scalable with additional RZ proxy devices in the trust system.

An intermediate proxy device, according to some embodiments, may be arranged along with one or more other intermediate proxy devices at a Rendezvous Zone (RZ) of a trust system having at least three deployment layers. For example, the intermediate proxy device may also include a processing device and memory, where the memory may be configured to store a device trust program having computing logic that enables the processing device to perform a step of communicating with a device trust manager that is configured as a backend system and is arranged at a top layer of the trust system. The device trust manager, for example, may be configured to manage multiple Internet of Things (IoT) devices distributed at a bottom layer of the trust system. The computing logic may further enable the processing device to conduct trust and security functions for a corresponding cluster of IoT devices of the multiple IoT devices via local agents embedded in the cluster of IoT devices to thereby operate on behalf of the cluster of IoT devices.

In some embodiments, the multiple IoT devices may be resource-constrained devices, embedded devices, or connected devices, wherein the local agent embedded in each respective IoT device may be enacted via an operating system of the IoT device. The computing logic may further enable the processing device to download a digital certificate from the device trust manager onto the cluster of IoT devices, wherein the digital certificate on each IoT device may be configured to identify and/or certify the respective IoT device. In some embodiments, the computing logic may further enable the processing device to perform firmware updates for the cluster of IoT devices.

Furthermore, the intermediate proxy device may further include middleware to enable the intermediate proxy device to act as an edge device for the cluster of IoT devices and to act as a throttle control for the device trust manager for scheduling communications between the multiple IoT devices and the device trust manager. In some embodiments, communication with the cluster of IoT devices may be asynchronous and may include intermittent connectivity. The communication with the cluster of IoT devices may be conducted using a connectivity protocol including one or more of Message Queuing Telemetry Transport (MQTT), Constrained Application Protocol (CoAP), Supervisory Control And Data Acquisition (SCADA), Advanced Message Queuing Protocol (AMQP), a pub/sub protocol, Bluetooth, and a lightweight customized protocol.

The intermediate proxy device, according to some embodiments, may work together with the one or more other intermediate proxy devices at the RZ to dynamically discover and connect clusters of IoT devices to corresponding intermediate proxy devices to evenly distribute loads among the intermediate proxy devices for load balancing and/or bypass intermediate proxy devices that are faulty or overloaded. The clusters of IoT devices may be located in different geographical areas and may be dynamically connected based on geographical proximity, availability, and operability, whereby a detection of faults and/or overloading conditions may be followed by an action of dynamically reassigning the clusters. The intermediate proxy device and the one or more other intermediate proxy devices may be controlled by a cluster control device to assign the clusters of IoT devices with corresponding intermediate proxy devices, wherein the cluster control device may be configured to synchronize data between the intermediate proxy devices using Intermediate System to Intermediate System (IS-IS) functionality.

The intermediate proxy device may be dedicated to a specific enterprise within an isolated cloud or customer cloud, wherein the cluster of IoT devices may also be located on the premises of the enterprise and may include connectivity with the intermediate proxy device using an on-premises bridge. The intermediate proxy device may be configured as one of a network switch, network router, Wi-Fi router, modem, Bluetooth router, edge node, and fog node. The trust system may include at least four deployment layers including a fog layer between the RZ and the top layer, wherein the fog layer may also include processing and/or computing functionality within the trust system. The computing logic may further enable the processing device to provide processing and/or computing functionality on behalf of each IoT device of the cluster of IoT devices when the processing and/or computing functionality is essentially transferred or offloaded from the cluster of IoT devices to the intermediate proxy device.

The computing logic may further enable the processing device to provide a) Operating System (OS) support, b) communication protocol support, c) security or PKI support, d) trust core SDK support, e) registration/identity support, f) threat intelligence support, and/or g) developer support, for the cluster of IoT devices. In some embodiments, each IoT device may be a refrigerator, freezer, oven, stove, kitchen range, microwave oven, dishwasher, coffee maker, espresso machine, toaster, toaster oven, air fryer, blender, mixer, food processor, juicer, slow cooker, pressure cooker, ice maker, washer, dryer, vacuum cleaner, barista machine, HVAC system, utility meter, smart door lock, security system, smoke detector, carbon monoxide detector, measuring and testing device, heartrate monitor, glucose monitor, temperature sensor, smart watch, smart ring, network equipment, network switch, router, modem, Wi-Fi access point, vending machine, sensor, camera, autonomous vehicle, medical equipment, personal medical device, medication administering device, or other electronic or manufactured device.

### Systems for Scheduling Firmware Updates

Building upon the foundational distributed IoT architecture disclosed in the embodiments described above (i.e., the parent application) — wherein a backend entity manages a fleet of IoT devices through a network of Rendezvous Zone proxy devices that perform trust and security functions at the network edge — the present application (i.e., this child or CIP application) extends that framework by introducing an intelligent, AI-driven firmware update management system that operates within and across that same distributed infrastructure. Specifically, where the parent application establishes the structural and communicative backbone for securely connecting and managing IoT devices at scale, the present application leverages that backbone as the substrate upon which a more sophisticated firmware update orchestration capability is built, one in which telemetry data and device parameters continuously flowing from the IoT device fleet are processed by the Device Trust Manager to generate predictive risk assessments, optimized update schedules, and autonomous remediation actions. In this way, the present application transforms a secure, connected device management platform into one that can intelligently anticipate, prevent, and recover from firmware update failures across large and geographically diverse IoT deployments, while minimizing human intervention and end user exposure to the underlying complexities of those systems and methods.

Software and firmware updates have become a standard feature in many IoT systems. For example, Over-the-Air (OTA) firmware update mechanisms may be used for deploying updates for certain IoT devices that can be difficult to reach. Conventional OTA systems allow device manufacturers and operators to remotely deploy firmware packages to connected devices, often with basic targeting capabilities such as device type, firmware version, or geographic grouping. These systems typically operate on a “deploy and passively observe” model — an update is packaged, validated at the server side, and transmitted to the target device, with success or failure reported after the fact. While such systems may include rudimentary retry logic or rollback triggers upon detection of a failed installation, they lack any meaningful capacity to anticipate failure before it occurs. The result is a reactive posture that is adequate for small, accessible fleets but increasingly untenable as deployments scale to millions of devices in diverse and often inaccessible environments. As such, the systems and methods of the present disclosure are configured to overcome these shortcomings of the conventional systems.

Also, as mentioned above, conventional systems generally treat all devices within a target group as functionally equivalent for purposes of update risk assessment. That is, if a firmware update is cleared for deployment to a class of devices, it is pushed uniformly without regard for device-specific or environment-specific risk factors — such as hardware revision, local environmental conditions like humidity or temperature, connectivity stability, or known chipset-level defects. Some existing platforms have introduced staged or canary rollouts, where an update is first pushed to a small subset of devices before broader deployment, as a way of catching failures early. While this is an improvement over fully uniform deployment, it is still fundamentally reactive and statistically dependent, offering no device-level risk prediction and no integration with external intelligence sources that might signal known vulnerabilities or impending fixes. Again, the present disclosure is configured to overcome these issues.

Therefore, the present disclosure improves upon the conventional systems by introducing a proactive, AI-driven risk assessment layer that operates before and during the update process. Rather than relying on post-hoc failure detection or blunt staged rollouts, the systems and methods herein continuously learn from historical update data, correlate outcomes with device-specific and environmental variables, and generate predictive risk scores that inform update scheduling and targeting decisions. Furthermore, by integrating with external data sources — such as chipset vendor advisories or bug-fix release timelines — the present systems can make context-aware decisions to delay or modify update deployment in ways that no prior reactive system could achieve. The addition of an intelligent remediation engine that can autonomously roll back failed updates further distinguishes the invention, effectively closing the loop between prediction, prevention, and recovery in a manner that is transparent to the end user.

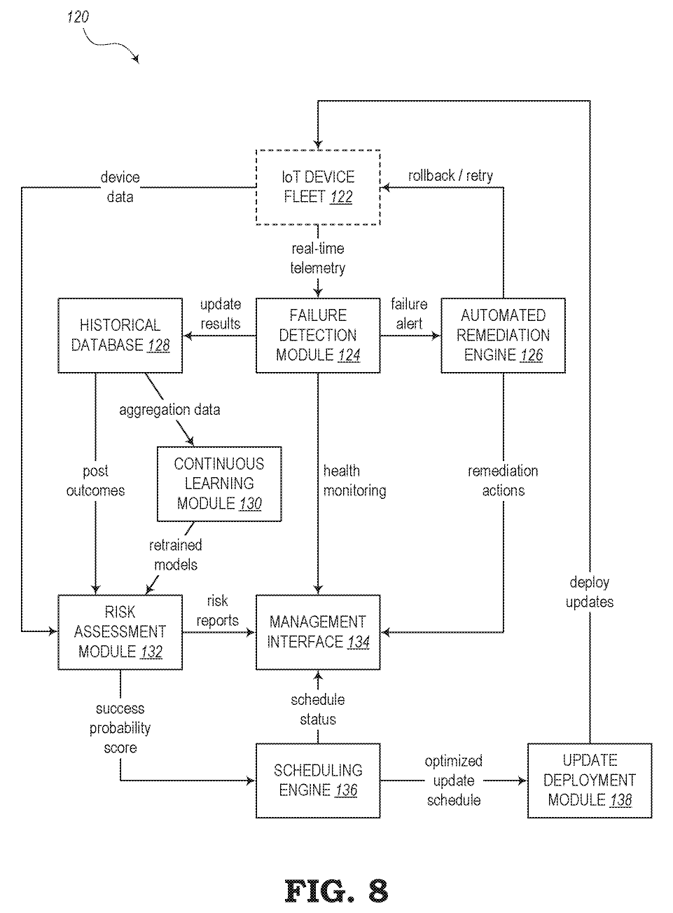

FIG. 8 is a block diagram illustrating an embodiment of a device trust manager 120 (e.g., a cloud-based manager). The device trust manager 120 may include the same or similar functionality as the digital trust system 16 and/or device trust manager 24 described in other embodiments discussed in the present disclosure. In some embodiments, the device trust manager 120 may be configured as an “IoT device management system” and may, in particular, be configured to schedule and conduct update procedures for updating the software or firmware embedded in the local agents of each IoT device in a fleet (or cluster) of IoT devices. In some embodiments, the components of the device trust manager 120 may be processing units integrated in the device updating module 66 shown in FIG. 5 for updating software/firmware in a remote fleet of IoT (or embedded) devices. The modules of the device trust manager 120 may include Artificial Intelligence (AI) or Machine Learning (ML) techniques and algorithms to enable training on past updates and retraining as needed to improve the updating procedures.

As shown in FIG. 8, the device trust manager 120 includes interactions with an IoT device fleet 122 (e.g., a group or cluster of IoT devices, embedded devices, resource-constrained devices, etc.) that may be associated with a specific end user entity (e.g., organization, enterprise, factory, etc.). Telemetry data can be received from the IoT device fleet 122 for monitoring the status of these devices. In response, the device trust manager 120 can deploy software/firmware updates on one or more of the IoT devices of the IoT device fleet 122, as needed.

The embodiment of the device trust manager 120 of FIG. 8 includes a failure detection module 124, an automated remediation engine 126, a historical database 128, a continuous learning module 130, a risk assessment module 132, a management interface 134, a scheduling engine 136, and an update deployment module 138. The update deployment module 138 is configured to deploy updates to the IoT device fleet 122 based on the various operations of the device trust manager 120. Also, if faults are detected during the software/firmware updates, the automated remediation engine 126 may be configured to send rollback or retry signals to the IoT device fleet 122 to roll the software/firmware back to a previous version and/or retry the update process.

The IoT device fleet 122 provides real-time telemetry to the failure detection module 124. Also, the IoT device fleet 122 sends device data and device characteristics to the risk assessment module 132. With the real-time telemetry data, the failure detection module 124 determines if a failure is detected or about to happen. The failure detection module 124 can send a failure alert to the automated remediation engine 126, which can then either retry any software update processes on the IoT device fleet 122 and/or may simply roll back the software/firmware to an earlier trusted version. Also, the failure detection module 124 sends update results to the historical database 128 for storage and sends health monitoring information to the management interface 134.

In response to receiving the update results from the failure detection module 124, the historical database 128 can send aggregated data to the continuous learning module 130 and may post outcomes to the risk assessment module 132. Also, the continuous learning module 130 can send retrained models to the risk assessment module 132. The risk assessment module 132 is configured to assess the risk of a failed update and/or risk of one or more of the IoT devices of the IoT device fleet 122 failing beyond repair. The risk assessment module 132 sends a risk report to the management interface 134. The risk assessment module 132 also sends a success probability score to the scheduling engine 136.

The scheduling engine 136 is configured to send schedule status information to the management interface 134. The management interface 134 also receives information about remediation actions from the automated remediation engine 126. The scheduling engine 136 is configured to send an optimized update schedule to the update deployment module 138. With the optimized update schedule, the update deployment module 138 is configured to deploy the updates to the IoT device fleet 122 in a loopback arrangement.

The systems and methods described in the present disclosure may be useful in a number of different application spaces, such as for IoT device management, firmware/software update deployment, and AI/ML-based predictive analytics. More specifically, it falls within the domain of secure, cloud-based lifecycle management platforms for large-scale IoT and operational technology (OT) device fleets, with a particular focus on intelligent, risk-aware update orchestration. Thus, the device trust manager 120 may be an AI-driven IoT firmware update system that additionally includes risk management capabilities.

The device trust manager 120 of FIG. 8 may serve as a security and management control plane for IoT device manufacturers, operators, and developers. The platform handles the full lifecycle of connected devices, including onboarding, certificate management, telemetry, and — most relevant to this invention — software/firmware updates. Customers can upload firmware directly to the platform and push it out to targeted subsets of their device fleet using various filtering mechanisms. This is already a working product.

The core problem that the device trust manager 120 addresses is the risk of failed firmware updates across large IoT fleets, potentially numbering in the millions of devices. A failed update can render a device completely unusable — "bricked" — and if that device is deployed in a physically inaccessible or hazardous location (e.g., in a nuclear plant, in a region that experiences extreme weather or natural phenomena, etc.), manual remediation may be impossible or prohibitively expensive. The business goal, then, is to maximize success rates and minimize failures during update procedures, ideally in a way that is entirely transparent to the customer.

An important aspect of the various embodiments is the AI/ML-based predictive systems that continuously learn from historical firmware update data. By analyzing patterns across large numbers of past updates, the system builds a predictive model that can assess the risk of a given update failing on a given device or class of devices before the update is actually pushed. The system is not static — it continuously refines its predictions as new update outcomes are recorded.

A concrete illustration of this learning capability is described here. For example, after analyzing a large volume of updates, the system might determine that thermostats deployed in high-humidity coastal regions fail firmware updates at roughly three times the rate of devices in non-coastal environments. This kind of environmental and contextual insight allows the platform to make intelligent, targeted decisions about when and whether to proceed with a given update.

In addition to intermediate RZ components and IoT devices, the system may integrate with other external data sources as well to enrich its decision-making. For example, if the system detects that a particular chipset has a known bug that would cause an update to fail, and external sources indicate that a fix for that bug is forthcoming, the system can intelligently delay the update rollout until conditions are more favorable. Thus, the present disclosure may be configured to encompass not just passive prediction but active intervention in the update workflow.

Finally, the system includes a remediation engine that can take corrective action — such as automatically rolling back a failed update — to restore device functionality without human intervention. The cumulative effect of the predictive, preventive, and remediation components is a system designed to make the entire update process seamless and failure-transparent from the customer's perspective, even when things go wrong under the hood.

### Examples

The following illustrative examples further describe the capabilities of the device trust manager 120. In a first example scenario, the risk assessment module 132 learns from historical usage data that a fleet of office thermostats is most idle between 2:00 AM and 5:00 AM on weekdays. Based on device-specific success probability scores, the scheduling engine 136 may schedule 500 low-risk devices for update deployment at 2:00 AM on a Tuesday, 300 medium-risk devices at 3:00 AM on a Wednesday with closer monitoring enabled, and 50 high-risk devices individually on a Thursday night with support personnel on standby.

In a second example scenario illustrating self-healing capabilities, an IoT device experiencing a critical boot failure during a firmware update triggers the failure detection module 124. The automated remediation engine 126 automatically restores the previously installed firmware version within approximately three minutes, verifies that the device boots normally, confirms that operational sensor readings (e.g., temperature measurements) are accurate, and logs the incident for the historical database 128. The end user of the device is unaware that any failure occurred, as the remediation is transparent and autonomous.

In a third example scenario, the management interface 134 displays a summary dashboard showing that 2,529 devices were updated successfully (a 98.5% success rate), 123 automatic rollbacks were performed by the automated remediation engine 126, and thirty high-risk devices are pending manual review. Based on aggregated failure data, the risk assessment module 132 generates a recommendation to delay deployment of a particular firmware version to devices having a specific chipset (e.g., a Broadcom/ARM chipset) until a corresponding firmware patch from the chipset vendor becomes available. This recommendation is derived from integration with external intelligence data sources, including chipset vendor advisories and known vulnerability databases.

In a fourth example scenario illustrating per-device risk scoring, a specific IoT device reports its current firmware version, battery level (e.g., 85%), network connectivity type and signal strength (e.g., 4G with two bars), and time since last activity (e.g., 30 minutes). The risk assessment module 132 analyzes these device-specific parameters against patterns learned from thousands of previous updates and generates a device-specific success probability score (e.g., 92%) for that individual device, rather than applying a uniform risk score to the device class.

In a fifth example scenario illustrating autonomous environmental discovery, after analyzing a large volume of update outcomes across the fleet, the continuous learning module 130 autonomously discovers that IoT devices deployed in industrial environments with high electromagnetic interference fail firmware updates at approximately three times the rate of devices in standard environments. This correlation was not pre-programmed as a risk factor; rather, the machine learning model of the risk assessment module 132 independently identified it from aggregated historical data. The continuous learning module 130 automatically updates the risk models to account for this environmental factor, reducing future failures by approximately 35%.

### Intelligent Update Orchestration

The embodiment of the device trust manager 120 of FIG. 8 is related to intelligent orchestration of software and firmware updates within a trust architecture. In some embodiments, the device updating module 66 of the device trust manager 24 shown in FIG. 5 may be configured to perform firmware updates according to the scheduling techniques described herein, along with additional remediations actions as needed if fault conditions are predicted. The embodiment introduces an AI-driven update orchestration framework configured to proactively assess risk, optimize update scheduling, detect failures in real time, and automatically remediate failed updates.

In particular, the embodiment introduces a device trust manager 120 configured to manage updates for an IoT device fleet 122, wherein the fleet may correspond to one or more clusters of IoT devices managed via RZ proxy devices. The device trust manager 120 includes a failure detection module 124, automated remediation engine 126, historical database 128, continuous learning module 130, risk assessment module 132, management interface 134, scheduling engine 136, and update deployment module 138.

Unlike conventional OTA systems that rely on reactive failure handling, the present embodiment employs machine learning models trained on historical update outcomes and device telemetry to generate predictive risk scores prior to deployment. These risk scores are used to determine update timing, targeting, and sequencing, thereby reducing the likelihood of update failure.

The system further operates in a continuous feedback loop in which update outcomes are stored in the historical database 128, aggregated, and used by the continuous learning module 130 to retrain predictive models. The retrained models are then used by the risk assessment module 132 to improve future predictions.

Additionally, the automated remediation engine 126 is configured to automatically execute corrective actions, including rollback or retry operations, in response to detected failures. This creates a closed-loop system that integrates prediction, detection, and remediation into a unified update orchestration framework.

According to various embodiments, the present disclosure is directed to systems and methods for orchestrating software and firmware updates for fleets of Internet of Things (IoT) devices within a distributed device trust system. In one embodiment, the device trust manager 120 is configured to receive telemetry data, operational parameters, device data, and other parameters and metric regarding the IoT devices themselves as well as environment conditions in which the IoT devices operate, device functionalities, operational and peak times, current firmware versions, battery status, among other metrics. This data is received from the plurality of IoT devices in order that the device trust manager 120 can generate predictive risk assessments associated with deploying a software or firmware update to one or more of the IoT devices. The device trust manager 120 may further include the scheduling engine 136 configured to determine an optimized update schedule based on the predictive risk assessments.

In some embodiments, the system further includes a failure detection module 124 configured to monitor update executions and detect anomalies or failures in real time, and an automated remediation engine 126 configured to automatically perform corrective actions, including rollback or retry operations.

In certain embodiments, the system includes a continuous learning module 130 configured to update one or more ML models based on historical update outcomes, thereby improving prediction accuracy over time. The system may therefore provide a closed-loop update orchestration framework that integrates prediction, scheduling, monitoring, and remediation. Advantageously, the disclosed embodiments enable proactive, risk-aware update deployment across large-scale IoT fleets, thereby reducing update failure rates and improving reliability of device operations.

The device trust manager 120 is configured to orchestrate software and/or firmware updates for an IoT device fleet 122 within the distributed trust system described herein. The device trust manager 120 may be implemented within the backend layer and may operate in conjunction with one or more Rendezvous Zone (RZ) proxy devices that facilitate communication with the IoT device fleet 122. The IoT device fleet 122 may include a plurality of IoT devices having local agents configured to provide telemetry and receive update instructions. The device trust manager 120 provides a closed-loop system for predictive, adaptive, and autonomous update orchestration across large-scale IoT device fleets.

The risk assessment module 132 is configured to receive device data and other characteristics from the IoT device fleet 122 and to generate a success probability score associated with deploying an update. The risk assessment module 132 may utilize one or more machine learning models trained on historical update outcomes. The scheduling engine 136 is configured to receive the success probability score and to generate an optimized update schedule for deploying updates to the IoT device fleet 122. The scheduling engine 136 may account for device usage patterns, connectivity conditions, and risk levels when determining the update sequence and timing. The update deployment module 138 is configured to deploy software or firmware updates to the IoT device fleet 122 according to the optimized schedule. The updates may be delivered via RZ proxy devices using secure communication protocols.

The failure detection module 124 is configured to monitor telemetry from the IoT device fleet 122 during and after update deployment to detect failures or anomalies. Upon detection of a failure, the failure detection module 124 may transmit a failure alert to an automated remediation engine 126. The automated remediation engine 126 is configured to perform corrective actions, including initiating rollback of a software or firmware update to a previously trusted version and/or retrying the update process.

The historical database 128 is configured to store update results and telemetry data. The continuous learning module 130 is configured to receive aggregated data from the historical database 128 and to retrain machine learning models, which are then provided to the risk assessment module 132.

The management interface 134 is configured to provide visibility into system operations, including risk reports, scheduling status, device health, and remediation actions. For example, the management interface 134 may be configured as a User Interface (UI) or other suitable display mechanism for displaying graphs, charts, tables, windows, etc. that a user (e.g., admin) may use for being informed of network activities within an enterprise domain or other environment where a number of IoT devices may be deployed.

### Method for Scheduling Firmware Updates in a Fleet of IoT Devices

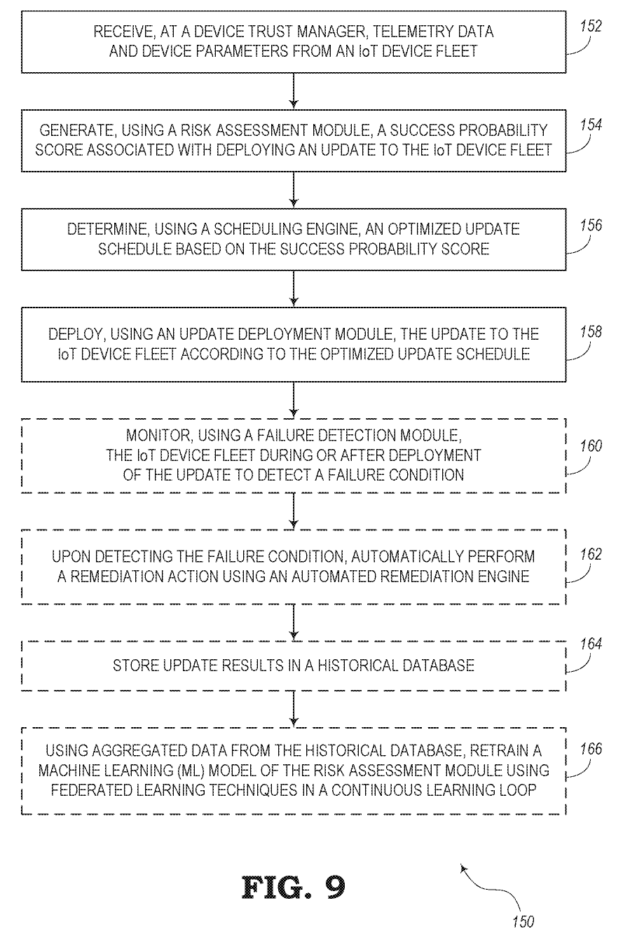

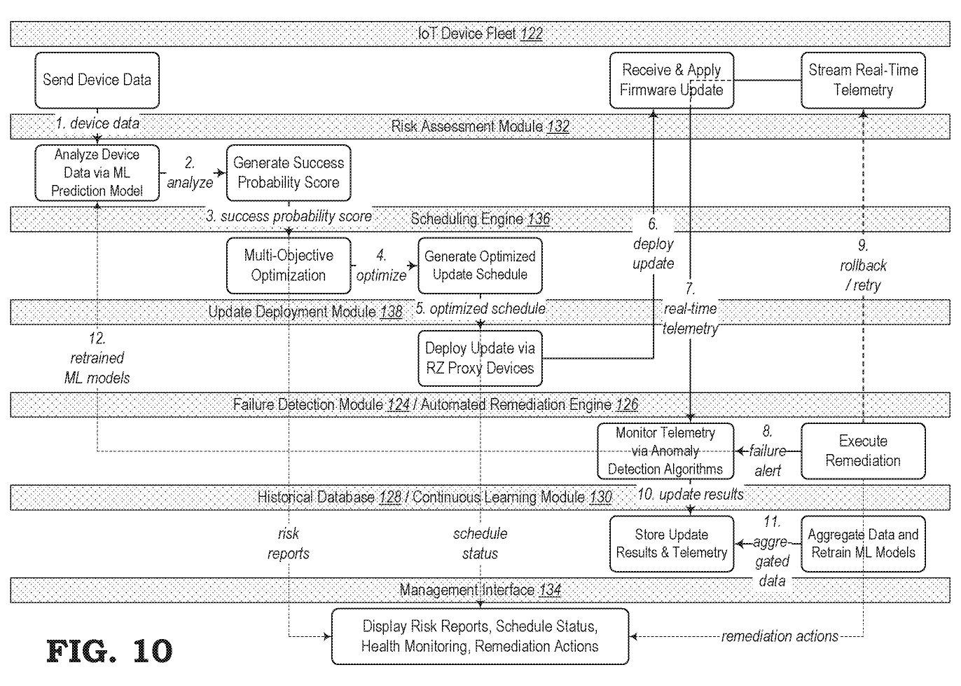

FIG. 9 is a flow diagram illustrating an embodiment of a method 150 for scheduling firmware updates for an IoT device fleet. As shown in this embodiment, the method 150 includes a step of receiving, at a device trust manager, telemetry data and device parameters from an IoT device fleet, as indicated in block 152. The method 150 further includes a step of generating, using a risk assessment module, a success probability score associated with deploying an update to the IoT device fleet, as indicated in block 154. Furthermore, the method 150 includes a step of determining, using a scheduling engine, an optimized update schedule based on the success probability score, as indicated in block 156. The method 150 also includes a step of deploying, using an update deployment module, the update to the IoT device fleet according to the optimized update schedule, as indicated in block 158. Thus, the block 152, 154, 156, and 158 may be associated with a main workflow for updating firmware. Additional steps are configured to further define the method 150.

For example, in some embodiments, the method 150 also includes a step (block 160) of monitoring, using a failure detection module, the IoT device fleet during or after deployment of the update to detect a failure condition (if any exist). Upon detecting the failure condition, the method 150 also includes a step (block 162) of automatically performing a remediation action using an automated remediation engine. These two steps (blocks 160 and 162) are related to handling situations where a fault, abnormality, or anomaly is detected or suspected (i.e., predicted). In this case, adjustments (e.g., rollbacks, retries, rescheduling, etc.) can be made to the original update schedule as needed.

In addition, method 150 may further include additional steps. That is, method 150 may include a step (block 164) of storing update results in a historical database. The update results may include update times, device types and locations, firmware versions replaced, and/or other metrics that may be useful for improving risk assessment and firmware update scheduling functions. Next, the method 150 includes a step (block 166) of using aggregated data from the historical database to retrain a Machine Learning (ML) model of the risk assessment module (e.g., using federated learning techniques). It may be noted that this constitutes a continuous learning loop for improving the AI/ML models by continual retraining.

### System Workflows

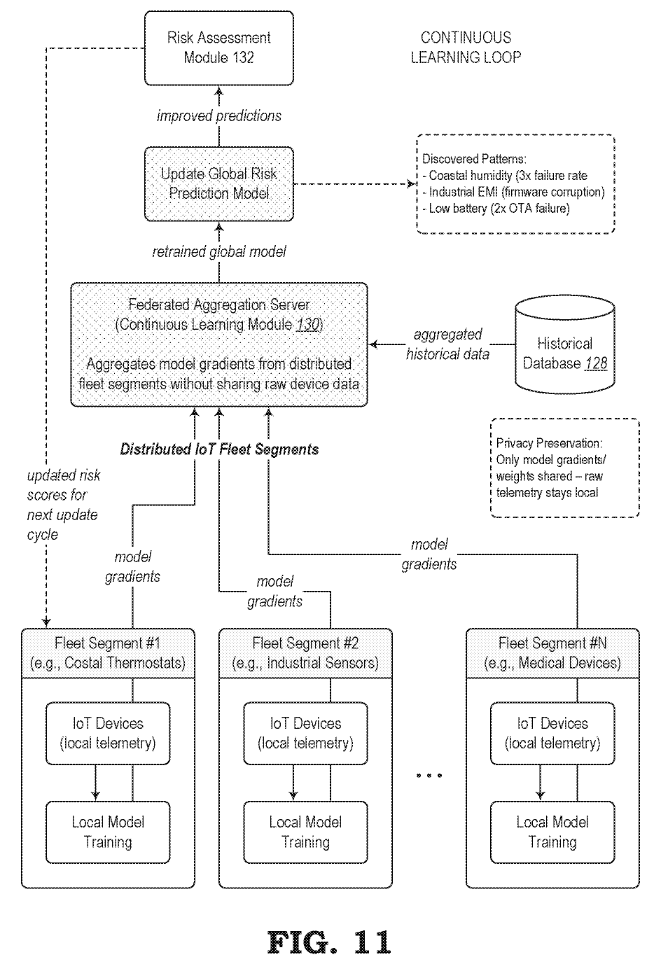

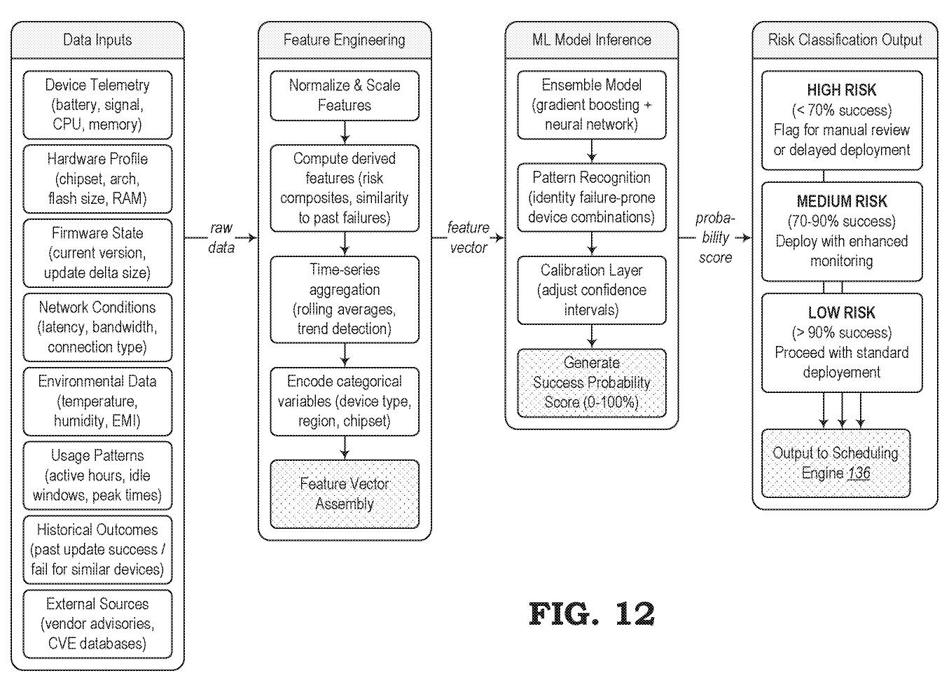

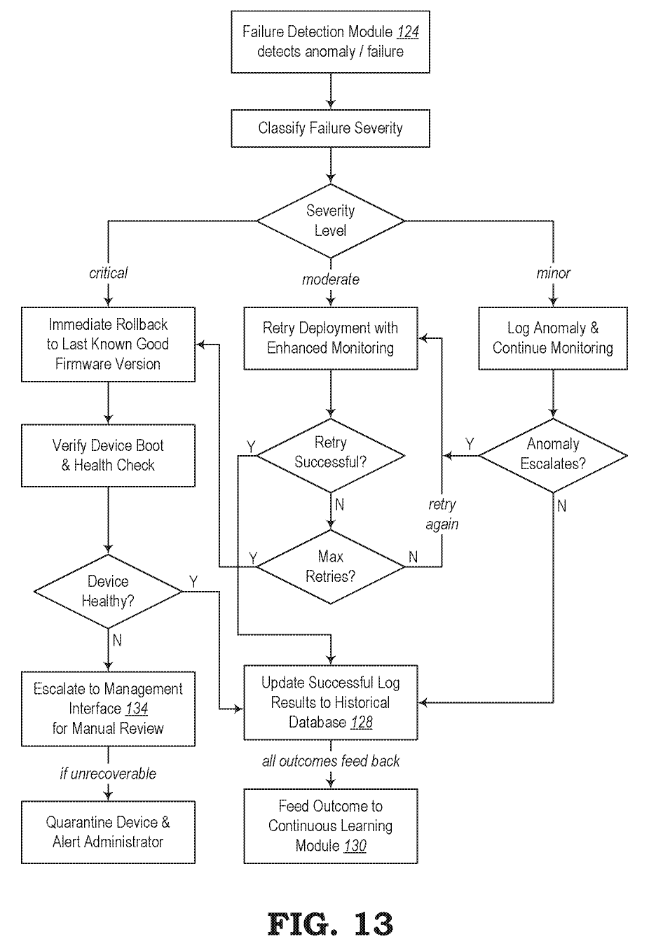

FIGS. 10-13 are workflows illustrating processes for operating the firmware updating and deployment systems described herein. FIG. 10 is a flow diagram showing a method associated with the device trust manager 120 for AI-driven firmware update orchestration. FIG. 11 is a flow diagram showing a method associated with the device trust manager 120 for performing a continuous learning loop with the historical database 128, continuous learning module 130, and risk assessment module 132, wherein a federated learning loop for continuous model improvement involves a distributed system of IoT fleet segments. FIG. 12 is a flow diagram showing a method for predicting firmware update success, whereby data inputs are applied as raw data to feature engineering elements. Feature vectors from the feature engineering elements are applied to an ML model inference component that is configured to generate a success probability score from 0 to 100. A risk classification output can be supplied to UI dashboard (e.g., scheduling engine 136) to show the probability score and related risks. FIG. 13 is a flow diagram showing a method for performing an automated remediation decision process.

### Additional Considerations

The agents embedded in the IoT unit 36 or IoT devices may be TrustEdge agents. The Device Trust Manager 24 may represent a device client for RTOS, Linux, Windows, etc., and in some embodiments may be powered by TrustCore.

The systems of the present disclosure may provide support for RTOS, Linux, Windows, MQTT (e.g., MQTT 3.1.1 / 5.0 client), SCEP client, etc. Other powerful capabilities may include TLS/SSL, DTLS, OpenSSL connector, Crypto import/export, Secure elements, FIPS 140-2/3 Level 1, etc. Also, the systems may be developer-friendly and include abstraction layers, may be simple to use, have great documentation, and provide premium support.

Also, the systems and methods of the present disclosure may be configured for compliance with FDA regulations. In some embodiments, the management interface 134 may be configured to generate audit trails and update deployment records compliant with FDA 21 CFR Part 11 requirements for electronic records and electronic signatures. The device trust manager 120 may further be configured to maintain complete traceability of firmware versions, update timestamps, rollback events, and remediation actions for each IoT device in the fleet, thereby supporting cybersecurity and compliance requirements with respect to Medical Devices: Quality System Considerations and Content of Premarket Submissions (Sept 2023), and other applicable regulatory frameworks.

TrustCore SDK, for example, may include cryptographic protection (e.g., confidentiality, integrity, authenticity, etc.) for all data types and uses, including firmware and code signing, plus PQC support (e.g., Dilithium). They may include simple-to-use APIs for interfacing with secure elements and crypto libraries, including OpenSSL connector. The protocols may include TLS 1.3, DTLS 1.3, MQTT over TLS, SCEP, FIPS 140-2 level 1 certified (with FIPS 140-3 in progress), etc.

A Software Trust Manager of the software trust portfolio 20 may include Threat Detection features to enhance the security of devices by scanning the device software for vulnerabilities. Vulnerability scanning, for example, may use FOSSA, ReversingLabs, Apple notarization, etc. This may generate SBOMs representing the software components on devices.

The Device Trust Manager 24 may be configured to import SBOMs from the Software Trust Manager or manually upload them. It may continuously monitor SBOMs for new CVEs. It may also provide an alert when new CVEs are found, even months or years later. Also, it may deploy OTA updates to affected devices using signed updates.

Therefore, the systems and methods described herein may be configured for managing a large number of connected devices in a distributed environment. Again, a current problem is that managing a substantial number (e.g., millions) of devices has always been a challenge for IoT and connected device manufacturers. Security aside, scalability is another issue which often becomes the first consideration for many users who are interested in achieving device management but are facing limitations such as air gapped environments, distributed systems, and other blockers.

The proposed solution of the present disclosure is configured to overcome these issues. The embodiments described herein are configured to take advantage of a three-layer approach model with backend, middleware (proxy), and agents on devices. This allows the backend or centralized system to manage millions of devices more efficiently and effectively. The approach described herein enables users to define security at “birth” and continue to evolve with the devices as they progress in their security journey. The novelty of the present approach, among other things, is the scalability and reliability model beyond just utilizing existing platforms or protocols.

In particular, the layered architecture includes 1) Backend – SaaS – (e.g., a cloud), 2) Rendezvous Zone – a middle layer that operates between the devices and the cloud, and 3) Local agents on the devices, wherein the devices are related to IoT technology, Object Oriented Technology (OOT), Supervisory Control And Data Acquisition (SCADA) technology, etc. Therefore, by deploying such a three-layered architecture, manufacturers or vendors of certain devices (e.g., smart fridges, etc.) do not need to build their own platform for managing the devices. Instead, they can implement the systems and methods described herein, which can provide better security, firmware updating, etc. for their IoT devices.

Thus, the Device Trust Manager 24 described herein, within the layered architecture, can provide a) the ability to support a large number of devices (on the order of tens of millions or more), b) the ability to communicate with devices having poor connectivity (e.g., vending machines that are not consistently connected to the Internet), which may include the MQTT protocol, c) the ability to offload processing from the devices to the RZ (e.g., the lowest level IoT devices do not need to have much computing capabilities), thereby allowing the RZ to do things like process certificates, authenticate, provide firmware updates, etc., among other things. It should be noted that the systems described herein are able to improve the traditional IoT management infrastructure by enabling scalability and security to a greater degree than what is possible with conventional systems.

From a remote location, a user (e.g., manufacturer, vendor, etc.) may be able to log into the Device Trust Manager 24, which may be hosted by a SaaS offering. The user may add an identity to a new device, which can happen via the CA back end. They could go ahead and update the device securely over the air. Next, they can go ahead and collect some analytics about these devices, such as 1) how many of them are on, 2) how many of them are off, 3) what firmware they are running, 4) if they are outdated, 5) when they have been updated, etc. Also, trust management may include threat intelligence for these devices.

In some cases, the manufacturer may incorporate software into their devices (e.g., kitchen appliances, medical devices, etc.) along with the hardware that might normally be a part of those devices that they are going to sell. Again, the devices could be vending machines, medical devices, networking equipment, kitchen appliances, or any other type of product that might be monitored in an IoT monitoring environment. One goal is that as long as a manufacturer has capable hardware as well as a supported operating system, the manufacturer can further install the “local agent” with other software in the memory of the device. This local agent, as described throughout the present disclosure, is embedded in the IoT device, and can thereby enable this device to be monitored according to the teachings of the present disclosure. Again, the IoT monitoring systems of the present disclosure are configured on at least three layers. The IoT layer, or end point zone, includes the IoT devices with the embedded agents configured in the operating systems of the IoT devices. In an initial step, the agent may be configured to connect to the backend service to register the device to allow the backend to manage it remotely.

Again, the communication between the centralized backend service system (e.g., SaaS) and the millions of IoT devices include one or more intermediate layers, which may include any suitable communication protocols, connectivity protocols, etc. Networking via the intermediate zone or RZ may include Wi-Fi routers, networking switch, wired routers, Bluetooth communication devices, etc., depending on the various configurations, microcontrollers, environments, amount of memory available, operating systems supported, among other factors. One example may include implementation with respect to Mobile Device Management (MDM) systems. In some embodiments, Internet access (to the backend) may include an intermediate RZ proxy device that is configured to represent one domain, one enterprise, one company, one organization, one university, etc. and may handle and manage up to hundreds or thousands of end point devices for the respective enterprise or whatever.

The embodiments described herein may be applicable to security, which may be added on top of regular IoT management. In this way, hackers will be unable to hack into an individual’s end point devices. The embodiments herein may minimize the footprint of the devices and appeal specifically to IoT environments, in which IoT devices, embedded device, and/or connected devices may be managed.

At the lowest level, one concern with IoT devices is the issue of enabling communication when communication is not so reliable. Although a laptop may easily access the Internet via wired or wireless connections using reliable networks, an IoT device, on the other hand, may often use unreliable communication methods. In some cases, an IoT device may use a satellite, or it could be a sensor on the bottom of the ocean, etc. Thus, it may be exceedingly difficult to have constant communication with these IoT devices. As such, the MQTT protocol may be chosen, which is a lightweight protocol that could be used for these devices.

The local agent on the IoT devices may be configured as a TrustEdge product that is configured to communicate with an edge in a trustworthy and secure manner. Various connectivity and/or communication methods may be used, such as asynchronous connectivity, any suitable pub/sub protocol, MQTT, etc. The local agents allow the devices to connect to and/or discover the multiple Rendezvous Zones (RZs), which can then maintain the “statefulness” of the devices or provide whatever services that can be offered to the devices. The agent can dynamically discover and connect to the available rendezvous zone element, and then the rendezvous zone element can get back to the main services on the backend or cloud service.

The agent essentially introduces the “smartness” into the IoT devices to create that dynamic connectivity model. Also, in some configurations, one IoT device is not necessarily associated with a single RZ proxy, particularly if the IoT is mobile and/or the RZ proxy devices are reassigned to different geographic areas. In addition, if one RZ device goes down (e.g., goes offline, is faulty, is overloaded, etc.) and can no longer act on behalf of a cluster of IoT devices, then the IoT devices and RZ proxy devices can be reassigned appropriately (e.g., with the help of the cluster control device 38). Thus, the connectivity between the lowest level and the RZ can be dynamic, whereby the clustering can be reconfigured as needed to redistribute and/or share the loads on each RZ proxy device 34, as wells as evenly split the traffic, reduce latency, improve communication performance, and perform other tasks to improve (or optimize) operation. Transport can be through any devices or protocols available, such as IP connectivity, application layer protocol, pub/sub, lightweight protocols (e.g., MQTT, Constrained Application Protocol (CoAP), etc.), and/or others.

In some embodiments, certain IoT devices may be confined to a single enterprise or domain. For example, some customer devices might not be exposed to the Internet directly (e.g., in a factory environment). Instead, these devices (e.g., assembly line machines) may be connected to an isolated cloud or customer cloud within a single domain. In some cases, the IoT devices may be extremely low-powered devices. Of course, it may be beneficial to avoid the leakage of trade secrets and maintain operating conditions with respect to the group of machinery operations within the domain. So, in this case, the enterprise may include an on-premises RZ device, bridge, or link that can connect the devices to other rendezvous zones that may be part of the cloud. On the other hand, some devices may directly access the Internet, such as in a home setting.

### Conclusion

Those skilled in the art will recognize that the various embodiments may include processing circuitry of diverse types. The processing circuitry might include, but are not limited to, general-purpose microprocessors; Central Processing Units (CPUs); Digital Signal Processors (DSPs); specialized processors such as Network Processors (NPs) or Network Processing Units (NPUs), Graphics Processing Units (GPUs); Field Programmable Gate Arrays (FPGAs); or similar devices. The processing circuitry may operate under the control of unique program instructions stored in their memory (software and/or firmware) to execute, in combination with certain non-processor circuits, either a portion or the entirety of the functionalities described for the methods and/or systems herein. Alternatively, these functions might be executed by a state machine devoid of stored program instructions, or through one or more Application-Specific Integrated Circuits (ASICs), where each function or a combination of functions is realized through dedicated logic or circuit designs. Naturally, a hybrid approach combining these methodologies may be employed. For certain disclosed embodiments, a hardware device, possibly integrated with software, firmware, or both, might be denominated as circuitry, logic, or circuits "configured to" or "adapted to" execute a series of operations, steps, methods, processes, algorithms, functions, or techniques as described herein for various implementations.

Additionally, some embodiments may incorporate a non-transitory computer-readable storage medium that stores computer-readable instructions for programming any combination of a computer, server, appliance, device, module, processor, or circuit (collectively “system”), each potentially equipped with one or more processors. These instructions, when executed, enable the system to perform the functions as delineated and claimed in this document. Such non-transitory computer-readable storage mediums can include, but are not limited to, hard disks, optical storage devices, magnetic storage devices, Read-Only Memory (ROM), Programmable Read-Only Memory (PROM), Erasable Programmable Read-Only Memory (EPROM), Electrically Erasable Programmable Read-Only Memory (EEPROM), Flash memory, etc. The software, once stored on these mediums, includes executable instructions that, upon execution by one or more processors or any programmable circuitry, instruct the processor or circuitry to undertake a series of operations, steps, methods, processes, algorithms, functions, or techniques as detailed herein for the various embodiments.

While the present disclosure has been detailed and depicted through specific embodiments and examples, it is to be understood by those skilled in the art that numerous variations and modifications can perform equivalent functions or yield comparable results. Such alternative embodiments and variations, which may not be explicitly mentioned but achieve the objectives and adhere to the principles disclosed herein, fall within its spirit and scope. Accordingly, they are envisioned and encompassed by this disclosure, warranting protection under the claims associated herewith. Additionally, the present disclosure anticipates combinations and permutations of the described elements, operations, steps, methods, processes, algorithms, functions, techniques, modules, circuits, etc., in any manner conceivable, whether collectively, in subsets, or individually, further broadening the ambit of potential embodiments.

What is claimed is:

1. A device trust manager comprising:
a risk assessment module configured to receive telemetry data and operational parameters from an IoT device fleet and generate a success probability score associated with deploying a firmware update to one or more IoT devices of the IoT device fleet;
a scheduling engine configured to determine an optimized update schedule based on the telemetry data, operational parameters, and success probability score; and
an update deployment module configured to deploy the firmware update to the one or more IoT devices according to the optimized update schedule.

2. The device trust manager of claim 1, further comprising a historical database configured to store metrics of firmware update procedures conducted by the device trust manager over time.

3. The device trust manager of claim 2, further comprising a continuous learning module configured to use aggregated data of the metrics of firmware update procedures from the historical database to retrain a Machine Learning (ML) model of the risk assessment module.

4. The device trust manager of claim 3, wherein the continuous learning module is configured to autonomously identify correlations between environmental conditions and firmware update failure rates without prior specification of the environmental conditions as risk factors.

5. The device trust manager of claim 3, wherein retraining the ML model uses federated learning techniques.

6. The device trust manager of claim 1, further comprising a failure detection module configured to monitor the IoT device fleet during or after the update deployment module deploys the firmware update in order to predict a failure condition.

7. The device trust manager of claim 6, wherein the failure detection module is configured to detect anomalies based on real-time telemetry data received from the IoT device fleet.

8. The device trust manager of claim 6, further comprising an automated remediation engine that, in response to the failure detection module predicting the failure condition, is configured to automatically perform a remediation action.

9. The device trust manager of claim 8, wherein the remediation action includes one or more of a) retrying deployment of the firmware update, and b) rolling back the firmware update to a previously installed version.

10. The device trust manager of claim 8, wherein the automated remediation engine is further configured to, after performing the remediation action, automatically verify functional recovery of the one or more IoT devices by confirming successful device boot, validating operational sensor readings, or verifying restored network connectivity.

11. The device trust manager of claim 1, further comprising a management interface dashboard configured to display one or more of a) a risk report, b) an update schedule status, c) a list of remediation actions taken, and d) health information.

12. The device trust manager of claim 1, wherein the scheduling engine is configured to determine the optimized update schedule by analyzing device usage patterns, environmental conditions, and device-specific risk factors.

13. The device trust manager of claim 1, wherein the update deployment module is configured to deploy the firmware update by transmitting the firmware update via one or more intermediate proxy devices arranged in a Rendezvous Zone (RZ).

14. The device trust manager of claim 1, wherein the IoT device fleet includes a plurality of resource-constrained devices or embedded devices having local agents configured to communicate with the device trust manager.

15. The device trust manager of claim 1, wherein the risk assessment module comprises a machine learning model trained on historical firmware update outcomes to generate the success probability score.

16. The device trust manager of claim 1, wherein the risk assessment module is further configured to receive external intelligence data comprising one or more of chipset vendor advisories, known vulnerability reports, and firmware patch availability timelines, and to adjust the success probability score based thereon.

17. The device trust manager of claim 1, wherein the risk assessment module is configured to generate a device-specific success probability score for each individual IoT device of the IoT device fleet based on device-level characteristics, rather than a class-level or group-level score applied uniformly to a device type or group.

18. The device trust manager of claim 1, wherein the risk assessment module, the scheduling engine, the update deployment module, a failure detection module, and a continuous learning module operate in a closed-loop feedback cycle, such that firmware update outcomes are stored, aggregated, and used to retrain a machine learning model, thereby improving prediction accuracy with each successive firmware update cycle.

19. A method comprising steps of:
receiving telemetry data and operational parameters from an IoT device fleet;
generating a success probability score associated with deploying a firmware update to one or more IoT devices of the IoT device fleet;
determining an optimized update schedule based on the telemetry data, operational parameters, and success probability score; and
deploying the firmware update to the one or more IoT devices according to the optimized update schedule.

20. The method of claim 19, further comprising a step of storing metrics of firmware update procedures conducted over time.

21. The method of claim 20, further comprising a step of using aggregated data of the metrics of firmware update procedures from a historical database to retrain a Machine Learning (ML) model configured to generate the success probability score.

22. The method of claim 19, further comprising a step of monitoring the IoT device fleet during or after the firmware update is deployed in order to predict a failure condition.

23. The method of claim 22, wherein, in response to predicting the failure condition, the method further comprises a step of automatically performing a remediation action including one or more of a) retrying deployment of the firmware update, and b) rolling back the firmware update to a previously installed version.

24. The method of claim 19, further comprising a step of displaying, on a User Interface (UI), one or more of a) a risk report, b) an update schedule status, c) a list of remediation actions taken, and d) health information.

25. A non-transitory computer-readable medium configured to store a device updating module having computer logic instructions that causes a processing device to perform steps of:
receiving telemetry data and operational parameters from an IoT device fleet;
generating a success probability score associated with deploying a firmware update to one or more IoT devices of the IoT device fleet;
determining an optimized update schedule based on the telemetry data, operational parameters, and success probability score; and
deploying the firmware update to the one or more IoT devices according to the optimized update schedule.

26. The non-transitory computer-readable medium of claim 25, wherein determining the optimized update schedule includes analyzing device usage patterns, environmental conditions, and device-specific risk factors.
